(19) United States
(12) Patent Application Publication
(10) Pub. No.: US 2003/0061078 A1
(43) Pub. Date: Mar. 27, 2003

(54) Method for providing information to manage queue and method for reserving service

(75) Inventors: Hiroshi Shimosako, Kawasaki (JP); Tomoko Bessho, Kawasaki (JP); Nobuo Yuasa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/101,058

(22) Filed: Mar. 20, 2002

(30) Foreign Application Priority Data
Sep. 27, 2001 (JP) 2001-297781

(51) Int. Cl. G06F 17/60

(52) U.S. Cl. 705/5; 705/1

(57) ABSTRACT

In a method for providing information to manage a queue, waiting state information for each of the services is managed. A waiting time for a desired service that a user desires is calculated based on the waiting state information. Available services are retrieved so as to be different from the desired service and have a necessary time shorter than the waiting time. And information concerning the available services is provided to the user.

### BACKGROUND OF THE INVENTION

1. Field of the Invention

The present invention generally relates to a method for providing information to manage a queue and a method for reserving a service, and more particularly to the method for providing information to manage a queue and a method for reserving a service that manage queues in an amusement park, a hospital, a bank, a shop, or a like and provide information for users to utilize their waiting times.

2. Description of the Related Art

In order to receive a service in an amusement park, a hospital, a bank, or a shop conventionally, a long queue of users who wait for their turn of receiving service may occur. Since the users cannot know information including a waiting time for the service, a process time and users per process required to conduct the service, the users have to wait for their turn of receiving service.

In order to solve problems described above, as conventional techniques, for example, there are a technique (Japanese Laid-Open Patent Application No.9-265497) in which a waiting time is provided to a user when the user reserves a service, a technique (Japanese Laid-Open Patent Application No.11-328589) in which an applicant who wants to make a reservation is notified of a reservation being available with higher priority when a vacancy occurs to make a reservation in a case in which it is impossible for the applicant to make a reservation, and a technique (Japanese Laid-Open Patent Application No.2000-270354) that notifies users, who are not waiting on site of a service, of the turn of the service via a mobile communication device or telephone. These conventional techniques accept a reservation from users for a service and provide users information for effectively receiving the service.

However, it is required for the users to wait in a long queue for their turns of receiving the service such as the amusement park, the hospital, the bank, the shop, or a like. Thus, such time consumption reduces the time available for receiving a service at another attraction. As for the service provider side, efficiency of providing users service is degraded.

Moreover, in the conventional techniques, in order to obtain information including the waiting time for the service, it costs for the users to individually possesses a device for making a reservation. On the other hand, even if the service provider possess such a device allowing the user to make a reservation, only information related to the service such a service start time based on reservation information is provided to the user. Accordingly, the users cannot effectively utilize their waiting time.

### SUMMARY OF THE INVENTION

It is a general object of the present invention to provide a method for providing information to manage a queue and a method for reserving a service in which the above-mentioned problems are eliminated.

A more specific object of the present invention is to provide a method for providing information to manage a queue and a method for reserving a service in which the queue for the service is managed and information concerning other services available during a waiting time for the desired service is provided to users.

The above object of the present invention is achieved by a method for providing information to manage a queue, including the steps of: (a) managing waiting state information for each of the services; (b) calculating a waiting time for a desired service that a user desires, based on the waiting state information managed in the step (a); (c) retrieving available services different from the desired service and having a necessary time shorter than the waiting time calculated in the step (b); and (d) notifying the user of information concerning the available services retrieved in the step (c).

In the method for providing information to manage a queue, when the user makes a reservation for a desired service, the waiting time for the desired service is calculated, the available services having a necessary time shorter than the above waiting time are retrieved based on the waiting state information, and then the waiting state information and the necessary time for each of the available services are provided to the user. By providing the information concerning the available services within the waiting time, the user can utilize the waiting time making use of the available services. Therefore, it is possible to manage the queue of users and effectively receive the desired service and the available services more efficiently.

The above object of the present invention is achieved by a method for reserving a desired service sent to a server managing a reservation for the desired service from a user terminal, including the steps of: sending reservation information showing a reservation for the desired service to the server; and receiving information concerning available services based on the reservation information and displaying the information at a display unit.

In the method for reserving a desired service, the reservation information for reserving the desired service is sent from the user terminal to the server, and information concerning available services sent from the server is displayed at the user terminal. Accordingly, it is possible to obtain the available services within the waiting time for the desired service.

Alternatively, the above object of the present invention is achieved by programs or a computer-readable recording medium recorded with program code for causing a computer to provide information to manage a queue and to reserve a desired service.

### BRIEF DESCRIPTION OF THE DRAWINGS

Other objects, features, and advantages of the present invention will become more apparent from the following detailed description when read in conjunction with the accompanying drawings, in which:

FIG. 1 is a diagram showing a network configuration;

FIG. 2 is a diagram showing a process time table stored in the process time DB;

FIG. 3 is a diagram showing the queue management table stored in the queue management DB;

FIG. 4 is a diagram showing a reservation management table stored in the reservation management DB;

FIG. 5 is a flowchart for explaining a method for providing information to manage a queue; and

FIG. 6 is a diagram showing a window example displayed at each of mobile information terminals.

### DESCRIPTION OF THE PREFERRED EMBODIMENTS

An embodiment of the present invention will be described with reference to drawings.

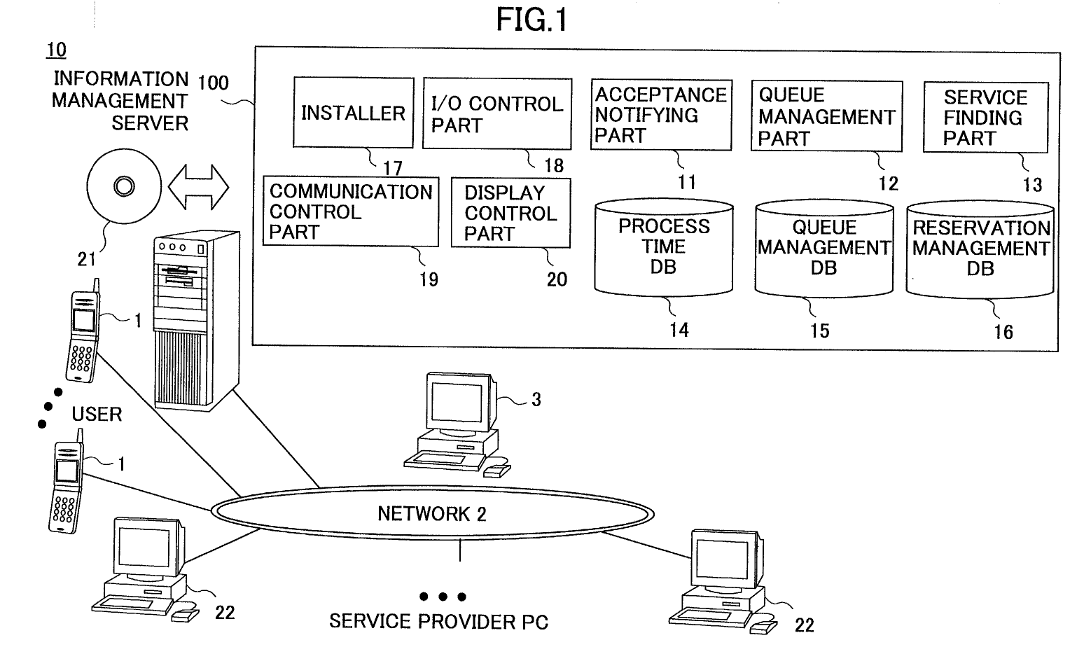

For example, a system applying a method for providing information to manage a queue and a method for reserving a service according to the embodiment of the present invention can be configured as shown in FIG. 1. In FIG. 1, a queue resolving information providing system 10 includes a information management server 100, a plurality of mobile information terminals 1, and a plurality of service provider PCs (Personal Computers) 22 provided at a service provider. It should be noted that the mobile information terminals 1 are not limited to cellular phones as shown in FIG. 1 but can be other types of information terminals.

In FIG. 1, the information management server 100 is a server computer and is controlled by a CPU (Central Processing Unit) The CPU conducts a process in the method for resolving queues in accordance with programs stored in a memory unit (not shown). The plurality of the mobile information terminals 1 and the plurality of service provider PCs 22 are connected to the information management server 100 via a network 2. The information management server 100 includes mainly an installer 17 for installing the programs executing a process for providing queue resolving information, an input/output (I/O) control part 18 for controlling an input/output of data, a communication control part 19 for controlling data communications, a display control part 20 to control displaying data at a display unit 3, an acceptance notifying part 11 for conducting a notifying process for notifying a user that a reservation made by the user is accepted, a queue management part 12 for conducting a process concerning queues based on information from the service provider PCs 22, and a service finding part 13 for conducting a process of finding information of other services, a process time DB (database) 14 for storing information of an average service process time per service, a queue management DB 15 for storing information including the number of users in a queue per service, and reservation management DB 16 for storing reservation information per service.

The installer 17 reads the programs according to the present invention from a CD-ROM (Compact Disc Read-Only) 21 storing the programs. The installer 17 installs the program in a storage unit (not shown). When the process in the method for providing information to manage a queue is executed, the CPU starts the process in accordance with the programs installed in the storage unit (not shown). It should be noted that a recording medium storing the programs is not limited to the CD-ROM 21 but can be any kind of computer-readable recording medium. The I/O control part 18 controls an input unit (not shown) such as a mouse, a keyboard, or a like, and controls an output unit (not shown) such as a printer, or a like, in order to control the input/output of data. The communication control part 19 is a processing part to control sending/receiving data via the network 2 and includes a communication unit (not shown) to connect to the network 2. The display control part 20 includes a display unit (not shown) such as a display, and controls displaying data at the display unit 3.

The acceptance notifying part 11 receives reservation from each of the mobile information terminals 1, and notifies each user of the information about a reservation of the user for a desired service. In addition, the acceptance notifying part 11 manages current waiting state information for each service provided by each of the service provider PCs 22. For example, the acceptance notifying part 11 manages users per service. In addition, the acceptance notifying part 11 updates the current waiting state information without waiting for information from the service provider PCs 22.

The queue management part 12 updates information in the queue management DB 15 and the reservation management DB 16 when reservations by the users using mobile information terminals 1 are accepted. Moreover, the queue management part 12 calculates a queue waiting time of the service reserved by the user, based on information stored in the process time DB 14 and the queue management DB 15. In addition, the process time DB 14 stores a process time, users per process, and a like for each service provided by service providers PCs 22.

The service finding part 13 finds utilization information of each of other services in that other services can be performed in less time than the queue waiting time, that is, a total time of the queue waiting time and the process time of each of other services is shorter than the queue waiting time of the service reserved by the user, based on information stored in the queue management DB 15 and the reservation management DB 16 and the queue waiting time calculated by the queue management part 12. Also, the service finding part 13 sends information concerning other services to the mobile information terminal 1 of the user based on information stored in the reservation management DB 16.

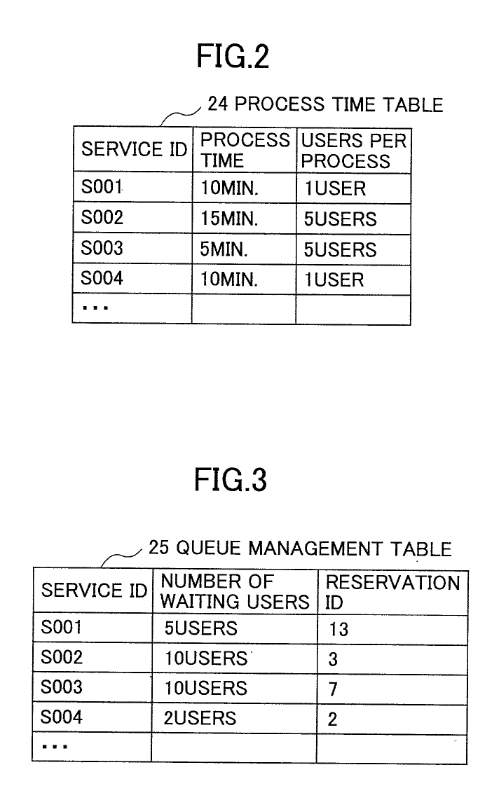

The information stored in each of databases 14, 15, and 16 will be described. FIG. 2 is a diagram showing a process time table 24 stored in the process time DB 14. By executing the queue management part 12 and the service finding part 13, information sent from the service providers PCs 22 is managed or referred to. In the process time table 24, the process time required and the number of users per process are stored for each service. For example, in the case of a service having the service ID S001, the process time required to provide the service to the user indicates 10 min. and the number of users per service indicates one user. In the case of a service having the service ID S002, the process time indicates 15 min. and the number of users per service indicates five users. In the case of a service having the service ID S003, the process time indicates 5 min. and the number of users per service indicates five users. In the case of a service having the service ID S004, the process time indicates 10 min. and the number of users per service indicates one user.

FIG. 3 is a diagram showing the queue management table 25 stored in the queue management DB 15. By executing the queue management part 12 and the service finding part 13, the queue management table 25 is managed and referred to based on information sent from the mobile information terminals 1. In the queue management table 25, the number of waiting users for a service corresponding to the service ID and a reservation ID that is the latest numbered are stored. For example, in the case of a service having the service ID S001, the number of waiting users indicates five users and the reservation ID shows thirteen.

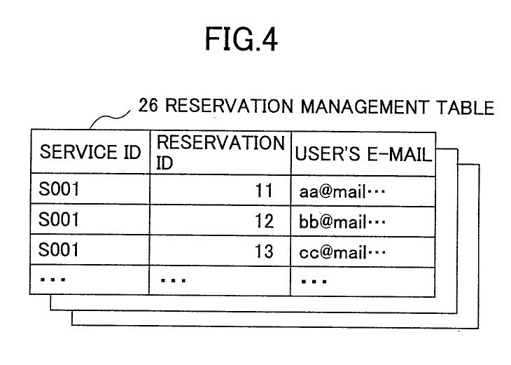

FIG. 4 is a diagram showing a reservation management table 26 stored in the reservation management DB 16. By executing the acceptance notifying part 11, the queue management part 12, and the service finding part 13, the reservation management table 26 is managed and referred to based on information sent from the mobile information terminals 1. The reservation management table 26 is a database to store information for managing information of users who are currently waiting for each service, and stores the reservation ID with respect to the service and user contact information for the reserved ID. For example, in a case of the service having the service ID S001, the reservation ID “11” and user's e-mail “aa@mail . . . ” corresponding to the reservation ID 11, the reservation ID “12” and user's e-mail “bb@mail . . . ” corresponding to the reservation ID “12”, the reservation ID “13” and user's e-mail “cc@mail . . . ” corresponding to the reservation ID “13”, . . . are provided.

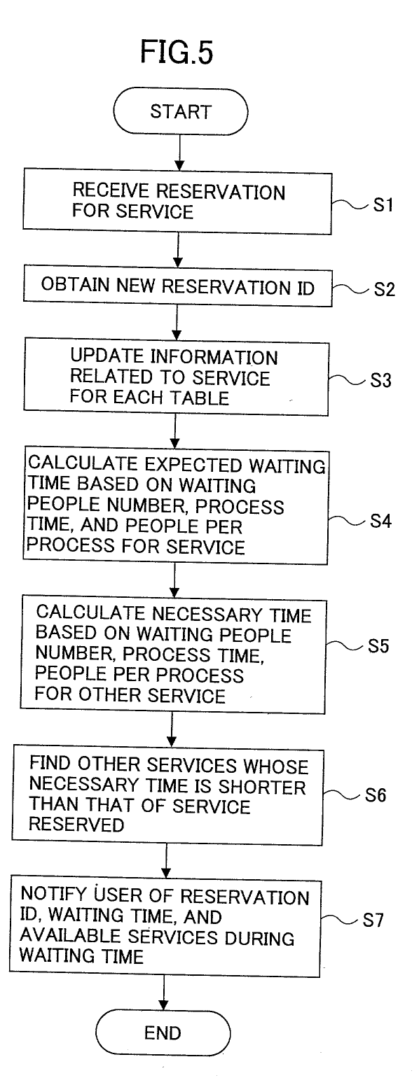

FIG. 5 is a flowchart for explaining the method for providing information to manage a queue. In FIG. 5, in step S1, the acceptance notifying part 11 accepts a reservation for a service desired by the user based on information sent from each of the mobile information terminals 1. In step S2, the acceptance notifying part 11 refers to the reservation ID for the service ID in the queue management table 25, and then numbers next reservation ID showing the turn of the user for the service reserved by the user. In step S3, the queue management part 12 updates the reservation ID which is for the service reserved by the user and stored in each of tables stored in databases 14, 15, and 16.

In step S4, based on the information stored in the process time DB 14 and the queue management DB 15, the queue management part 12 calculates a waiting time excluding a time of service with respect to the user by using the number of waiting users for the service reserved by the user, process time, and the number of users per service. For example, the waiting time is calculated by an expression:

$$waiting time = ( ( number of waiting users + 1 ) \div number of users per process - 1 ) \times process time .$$

In step S5, the queue management part 12 calculates a necessary time including the time of service for the user by using the number of waiting users, the process time, and the number of users per service. For example, the necessary time is calculated by an expression:

$$necessary time = ( number of waiting users + 1 ) \div number of users per process \times process time .$$

In step S6, based on information calculated in the step S4 and the step S5, the utilization information related to other services available within a necessary time shorter than the waiting time of the service reserved by the user. In step S7, the service finding part 13 provides the reservation ID numbered in the step S2, the waiting time calculated in the step S4, and the utilization information concerning other service available within the waiting time of the service in step S6, to the mobile information terminals 1 of the user. In addition, in the step S6, when the service finding part 13 finds other services, the service finding part 13 searches for other services located nearer to the service reserved by the user with higher priority. Alternatively, the service finding part 13 can retrieve other services located in a range predetermined by the user.

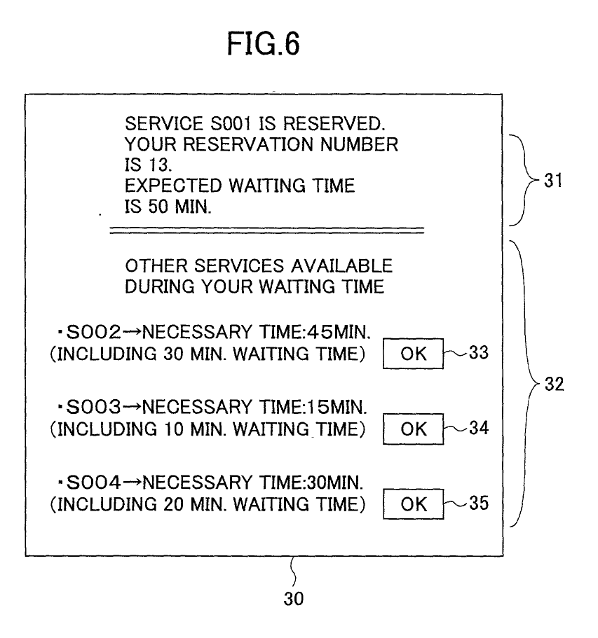

A window example at each of the mobile information terminals 1 will be described. In the window example, information provided in the step S7 is displayed. FIG. 6 is a diagram showing the window example displayed at each of the mobile information terminals 1. In each of the mobile information terminals 1, information sent from the information management server 100 is displayed at a window 30 as shown in FIG. 6. The window 30 displays a notice of reservation acceptance in a display area 31, the reservation number “13”, and an expected waiting time “50 min.”, displays the utilization information concerning other services available within the waiting time in a display area 32, and displays detailed information for each of other services and OK buttons 33 through 35 corresponding to other services, respectively.

For example, in the display area 32, with respect to a service having the service ID S002, “NECESSARY TIME: 45 MIN. (INCLUDING 30 MIN. WAITING TIME)” and the OK button 33 are displayed. “NECESSARY TIME: 45 MIN. (INCLUDING 30 MIN. WAITING TIME)” shows a result of adding the queue waiting time and a time for actually receiving the service having the service ID S002. With respect to a service having the service ID S003, “NECESSARY TIME: 15 MIN. (INCLUDING 10 MIN. WAITING TIME)” and the OK button 34 are displayed. With respect to a service having the service ID S004, “NECESSARY TIME: 30 MIN. (INCLUDING 20 MIN. WAITING TIME)” and the OK button 35 are displayed. When the user makes a reservation for the service having the service ID S001 and wants to receive the service having the service ID S002 while waiting for the service having the service ID S001, the user clicks the OK button 33 and a selection by the user is sent to the information management server 100. Information showing that the reservation for the service having the service ID S002 is accepted is provided to the mobile information terminal 1 of the user. Then, the user can receive the service.

Furthermore, after the service having the service ID S002, for example, it is possible to provide information concerning other services next available to the user when the user inputs the reservation ID for the service ID S001.

As described above, according to the present invention, it is possible to display the waiting time for the service reserved by the user, the total time of the waiting time and the necessary time to provide other services to the mobile information terminals 1. The user can make a reservation for other services and receive other services while waiting for the service first reserved. Therefore, it is possible for the users to effectively utilize their waiting time for the service. Moreover, it is possible for the service providers to effectively provide more services to the users since it is possible to channel the users having useless waiting time for the service to other services.

In FIG. 5, a process in the step S3 corresponds to a managing step, a process in the step S4 corresponds to a calculating step, and processes in steps S5 and S6 correspond to a service finding step.

The present invention is not limited to the specifically disclosed embodiments, variations and modifications, and other variations and modifications may be made without departing from the scope of the present invention.

The present application is based on Japanese Priority Application No.2001-297781 filed on Sep. 27, 2001, the entire contents of which are hereby incorporated by reference.

What is claimed is:

1. A method for providing information to manage a queue, comprising the steps of:
(a) managing waiting state information for each of services;
(b) calculating a waiting time for a desired service that a user desires, based on the waiting state information managed in said step (a);
(c) retrieving available services different from the desired service and having a necessary time shorter than the waiting time calculated in said step (b); and
(d) providing information concerning said available services retrieved in said step (c).

2. The method as claimed in claim 1, wherein with respect to said desired service, said step (b) calculates a number of processes excluding one service for the user based on a number of waiting users and a number of users per process, and multiplies the number of processes by a process time to obtain the waiting time.

3. The method as claimed in claim 1, wherein with respect to said available services, said step (c) calculates a number of processes including one service for the user based on a number of waiting users and a number of user per process, multiplies the number of processes by a process time to obtain the necessary time, and retrieving said available services having the necessary time shorter than the waiting time calculated in said step (b).

4. A computer-readable recording medium recorded with program code for causing a computer to provide information to manage a queue, comprising the code for:
(a) managing waiting state information for each of services;
(b) calculating a waiting time for a desired service that a user desires, based on the waiting state information managed in said code (a);
(c) retrieving available services different from the desired service and having a necessary time shorter than the waiting time calculated in said code (b); and
(d) providing information concerning said available services retrieved in said code (c).

5. A method for reserving a desired service sent to a server managing a reservation for the desired service from a user terminal, comprising the steps of:
sending reservation information showing a reservation for the desired service to said server; and
receiving information concerning available services based on the reservation information and displaying the information at a display unit.
